(19) United States
(12) Patent Application Publication
(10) Pub. No.: US 2025/0242984 A1
(43) Pub. Date: Jul. 31, 2025

(54) POWDER-LIQUID MIXING CAP AND CONTAINER

(71) Applicants: Alain JACCARD, Sainte-Croix (CH); SWISS PEAK TECHNOLOGIES SA, Geneve (CH)

(72) Inventor: Alain JACCARD, Sainte-Croix (CH)

(21) Appl. No.: 18/855,336

(22) PCT Filed: Apr. 7, 2023
(86) PCT No.: PCT/US2023/017824

§ 371 Date: Oct. 9, 2024

Related U.S. Application Data
(60) Provisional application No. 63/329,371, filed on Apr. 9, 2022.

(51) Int. Cl. B65D 51/28; A61J 1/20; B65B 3/00; B65B 7/28; B65D 51/00

(52) U.S. Cl. CPC B65D 51/2828; A61J 1/2093; B65B 3/003; B65B 7/28; B65D 51/002

(57) ABSTRACT

Provided is a mixing cap (10) attachable to a product chamber (4) for accommodating a product (8), the mixing cap (10) including an additive chamber (14) for accommodating an additive (12), the additive chamber (14) being defined by a flexible shell (20) surrounding an inner cavity (21) of the additive chamber (14), the flexible shell (20) being deformable to open towards the product chamber (4) for introducing the additive (12) into the product (8), a container device (2) with such a mixing cap (10) and a method for mixing a product composition (8, 12) out of the product (8) and the additive (12). FIG. 1

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to a container, such as a vial, a bottle or jar, comprising a product chamber for containing a product, which product chamber has an outwardly opening product opening, a closure member mounted on the product opening, and an additive chamber for containing an additive. Either the product or the additive is a powder, and the other is a liquid. The present invention also relates to the filling and the use of such a container for containing an edible, drinkable, ingestible or injectable therapeutic, an edible, drinkable, or ingestible consumable, or a cosmetic composition, or any consumable for any use, including industrial use.

Containers for mixing of a product and an additive are known. For example, the product chamber of the container is filled with water, while the additive chamber contains a drink concentrate. In order to make the mix, the user must first remove the closure member from the product opening. Then, the user must open the additive chamber and subsequently pour the drink concentrate into the product opening. Finally, the user must shake the container in order to mix the drink concentrate with the water. A number of studies report that even in the case of preparing a self-medication, users tend to not shake the container sufficiently to ensure complete mixing of the product and additive, resulting in an uneven dissolution of the additive in the product. This problem is even made more acute when one of the additive or the product is a powder. An incorrect mixing leads to the formation of clumps and/or lumps that may damage the patient's gastrointestinal tract in case of ingestible medication, or make the injection impossible because the clumps and/or lumps clog the injection needle. Further, such uneven dissolution may lead to loss of efficiency of the medication and/or to damages provoked by a locally too high concentration of the medication in the patient's organism.

It can be desirable to make the mixing of the product and additive just before use for several reasons, for example, in the case of a drink, it may be a fun experience for the user to observe the mixing before drinking. In other cases, it may be desirable for production costs reasons or for keeping production method secrets, to produce the additive in one factory and to distribute the additive to local factories that make only the product. In other cases, it is necessary that the additive and the product are kept separate until just before use such as, for example, with lyophilized biologic drug products, vaccines or pharmaceuticals. In other cases it is necessary that the additive is kept under specific storage conditions, such as being protected from light or being kept at very low temperatures until just before use such as, for example, with lyophilized biologic drug products, vaccines or pharmaceuticals, and in such case it can be more economic to store the additive and the product separately.

### SUMMARY OF THE INVENTION

An object of the invention is to provide a mixing cap, container, system and a method that ensures the mixing of a product and an additive while avoiding the formation of clumps or lumps and not relying on the user's performance for ensuring the mixing by shaking.

This task is solved by a mixing cap attachable to a product chamber for accommodating a product, the mixing cap including an additive chamber for accommodating an additive, the additive chamber being defined by a flexible shell surrounding an inner cavity of the additive chamber, the flexible shell being deformable to open towards the product chamber for introducing the additive into the product.

This task is also solved by a medical system, preferably a syringe, an intravenous line or subcutaneous line, the medical system connectable to a patient and including such a mixing cap. Therefore, the technology may be used as a part of a medical procedure to diagnose or treat a health disorder, to help prevent one or to alleviate a handicap, as a stand-alone mixing container used as repository for a drinkable or injectable substance, or as part of, or connected to, a tubing or line linkable to any part of a patient's body.

This task is also solved by a container device for accommodating a composition of a product and an additive, the container device including such a mixing cap, and a product chamber, wherein the mixing cap is attached to the outwardly disposed product opening of the product chamber.

This task is also solved by a method of mixing a product and an additive using a container device for accommodating a composition, the container device including a product chamber for accommodating the product and a mixing cap including an additive chamber for accommodating the additive, wherein the additive chamber comprises a flexible shell surrounding an inner cavity of the additive chamber, wherein the product chamber has an outwardly disposed product opening, the method including the steps of:
deforming the flexible shell of the additive chamber by changing a pressure difference within the inner cavity compared to the outside of the additive chamber, and
releasing the additive towards the product, when the additive chamber is opened towards the product chamber.

This task is also solved by a method of filling a container device for accommodating a composition, the container device including a product chamber for accommodating a product, which product chamber has an outwardly disposed product opening, and such a mixing cap for accommodating an additive, the method including the steps of:
providing an additive chamber of the mixing cap with an additive,
filling the product chamber with the product in a pressurized atmosphere, or filling the product chamber with the product at ambient pressure and adding a highly-refrigerated liquid gas in the product chamber, preferably before closing; and
attaching the mixing cap to the product chamber.

The terms “product” and “additive” merely indicate a first composition and a second composition, respectively. These two compositions, i.e., the product and the additive, may each comprise one or more components and/or ingredients. The product and additive form two different compositions in which at the mixing temperature, the first of the product and the additive is a gas or liquid possibly containing solid particles The second of the product and the additive being a solid, preferably a powder, particulate or a granulate, possibly embedded in a fluid, preferably liquid or an inert gas or gas or the like. In this disclosure “powder”, “particulate” and “granulate” are considered synonyms and may be interpreted as fine, dry particles produced by the grinding, crushing, or disintegration of a solid substance, or by the lyophilisation of a liquid substance. Furthermore, the term “product composition” indicates the mixture of the product with the additive.

The product chamber is typically made of glass or of any other appropriate material such as polymers or other materials, optionally transparent so that the user can see the product and observe the mixing process. Optionally, the product chamber is made of any standard container, vial, bottle, jar or similar, and the additive and other components for providing the mixing function are preferably integrated in the mixing cap that can be attached, snapped or screwed onto this product chamber.

The invention is based on the realization, that the opening of the flexible shell towards the product chamber leads to a high grade of turbulence during mixing of the product composition, the product composition comprising the product and the additive. The opening of the flexible shell is preferably sudden. The opening will therefore give an impulsion to the additive. Therefore, the mixing of additive with the product will lead to a product composition which is lump-free. More precisely, the pressure difference to be changed may be between the inner cavity and the product chamber, therefore leading to a deformation of the flexible shell between the inner cavity and the product chamber. This deformation of the inner shell, the inner shell being arranged between the inner cavity and the adjacent product chamber, will cause the opening of the flexible shell. The opening of the flexible shell may preferably be a breakage or sudden opening.

Such a mixing cap may be mounted on the product chamber. The product chamber may be a standard container. The method of mixing the product with the additive may contain the further step of shaking the container device, when the additive is mixed with the product.

In a further development, one of the product and the additive is a solid, preferably a powder, a particulate or a granulate, embedded within a fluid surrounding the solid, and the other of the product and additive is a liquid. Preferably, the fluid surrounding the powder is a gas, more preferably an inert gas, or a liquid. When the flexible shell is opened towards the product chamber, the difference in pressure between the inner cavity and the product chamber leads to a high level of blending. The deformation of the flexible shell may therefore be realized by the fluid or the liquid of either the product or the additive respectively.

The product contained in the product chamber may be a liquid able to mix with the additive, optionally to dissolve the additive. The product may be clean, optionally sterilized water, optionally injectable water with an appropriate level of isotonicity. The product can be any other liquid, as appropriate. According to the product being accommodated within the product chamber, the additive contained in the additive chamber may be a liquid, a powder, a particulate, a granulate, or similar form, and may contain salts, sugar, natural or artificial flavors, colorant, lyophilized biologic drug products, vaccines or pharmaceuticals or the like.

The additive chamber may be gas-tight so as to keep the additive in a dry condition for storage and includes portions of flexible gas-tight material. A typical material used for the flexible gas-tight material may be silicone, any material known to be used to make medical septum, or the like.

In a further development of the mixing cap, the flexible shell has a first area arrangeable immediately or in the vicinity of the product chamber, which first area is arrangeable between the product chamber and the inner cavity, the first area having an opening zone, wherein a deformation of the first area causes opening of the opening zone towards the product chamber, the area of the opening zone constituting at least 30%, preferably 50%, more preferably 70%, of the first area. Therefore, the opening or breakage of the first area, which may be a bursting, is highly effective for mixing the additive with the product.

In a further development of the mixing cap, the flexible shell has a second area located behind the inner cavity of the additive chamber relative to the first area of the flexible shell, wherein a change of pressure within the inner cavity may be initiated or is causable by a deformation of the second area. Therefore, the opening of the first area of the inner shell may be triggered or is triggerable with the help of applying pressure to the flexible second area of the flexible shell. The fluid or liquid within the inner cavity of the additive therefore transmits the pressure the second area is exposed to to the first area of the flexible shell, leading to the deformation and subsequently opening of the first area of the flexible shell. Therefore, the second area of the flexible shell is adapted to be deformed by further elements or manually. For instance, the second area of the flexible shell is adapted to be mechanically exposed to additional pressure for mixing the product with the additive to obtain the product composition, in other words the mixture of the product with the additive.

In a further development of the mixing cap, the product chamber is pressurizable with a pressure P1, the mixing cap including a propulsion chamber located behind the additive chamber relative to the product chamber, the propulsion chamber pressurizable with a pressure P2 that is superior to the ambient pressure and inferior to the pressure P1, the outwardly disposed product opening of the product chamber for allowing a decrease of the pressure of the product chamber from pressure P1 to ambient pressure for the deformation of the first area of the flexible shell, the pressure P2 of the propulsion chamber causing the deformation of the second area of the flexible shell. In a further development of the container device, the product chamber is pressurizable with a pressure P1, the mixing cap including a propulsion chamber located behind the additive chamber relative to the product chamber, the propulsion chamber being pressurizable with a pressure P2 that is superior to an ambient pressure and inferior to the pressure P1, the outwardly disposed product opening allowing for a decrease of the pressure of the product chamber from P1 to ambient pressure, the pressure P2 of the propulsion chamber generating a deformation and the opening of the additive chamber towards the product chamber. Therefore, the deformation and subsequently the opening of the first area of the flexible shell can be accomplished.

In a further development of the mixing cap, the product chamber is pressurizable with a pressure P1, the mixing cap including a spring located behind the additive chamber relative to the product chamber, the spring able to apply a force for the deformation of the second area of the flexible shell towards the product chamber with a pressure P2 that is superior to the ambient pressure and inferior to the pressure P1, the outwardly disposed product opening of the product chamber allowing for a decrease of the pressure of the product chamber from the pressure P1 to ambient pressure for the deformation of the first area of the flexible shell. This is a possibility for opening the first area of the flexible shell.

In a further development of the mixing cap, the second area of the flexible shell is manually deformable towards the first area of the flexible shell for deformation of the first area of the flexible shell for opening the additive chamber towards the product chamber. Therefore, by, for instance, pressing a finger onto the second area of the flexible shell, the breakage of the first area of the flexible shell can be accomplished or is accomplishable.

In a further development of the mixing cap, the deformation and opening of the first area of the flexible shell is adapted for projecting the additive towards the product for mixing of the additive with the product. Therefore, the mixing of the product composition is achievable independently from the position of the container device relative to gravity.

In a further development of the mixing cap, the additive chamber includes a mechanical structure pre-tensioned and/or presenting mechanically bistable properties that enhance the projection of the additive.

A further development of the mixing cap includes a bistable element, which bistable element is adapted to not effect the flexible shell in a first stable position and causing the deformation of the flexible shell in a second stable position. Therefore, the projection of the additive into the product may be enhanced by this bistable element.

In a further development of the mixing cap, the flexible shell comprises internal protrusions. These internal protrusions point towards the inside of the additive chamber. The internal protrusions are for preventing the compacting of the additive during storage or during the mixing of the product with the additive.

In still a further development of the mixing cap, the first and/or the second areas of the flexible shell is pierceable for allowing an extraction of the product or a product composition, which product composition is a mixture of the product and the additive, preferably via a hollow needle. Therefore, the flexibility of the first and/or second areas of the flexible shell provides the possibility for the flexible shell to function as a septum for removing product composition or the product only from the container device.

In a further development of the mixing cap and a further development of the container device, the additive chamber is arranged or arrangeable respectively to penetrate a plane of the outwardly disposed product opening or where the additive chamber is arranged or arrangeable within the product chamber. The additive chamber being arranged/arrangeable within the product chamber means in other words, that the product chamber forms an inner product chamber cavity limited by the walls of the product chamber and the plane of the outwardly disposed product opening and the additive chamber is arrangeable or arranged respectively within this inner product chamber cavity. The additive may be insoluble or substantially partly insoluble. To facilitate the mixing of such an additive, the additive chamber is arrangeable immediately at the surface of the product by the additive chamber penetrating the plane of the outwardly disposed product opening. Therefore, the release of the additive is accomplished into the product, when mixing the product composition. By penetrating the plane of the outwardly disposed product opening, the additive chamber is arrangeable immediately at the surface of the product. Therefore, the additive chamber may be at least partially immersed in the product chamber.

In a further development of the container device, the composition after mixing is an edible, drinkable, ingestible or injectable therapeutic, an edible, drinkable, or ingestible consumable, or a cosmetic composition.

In a further development of the method of mixing a product and an additive, the flexible shell has a first area arranged immediately at the product chamber and a second area located behind the inner cavity of the additive chamber relative to the first area of the flexible shell, wherein the method includes the steps of:
deforming the second area of the flexible shell and therefore changing the pressure within the inner cavity, preferably raising the pressure within the inner cavity, and
causing deforming of the first area due to the changing pressure within the inner cavity until the additive chamber opens towards the product chamber.

In a further development of the method of filling the container device, the method comprises the step of:
filling a propulsion chamber of the mixing cap with pressurized gas, or inserting a highly-refrigerated liquid gas in the propulsion chamber, or inserting a spring in the mixing cap behind the additive chamber to apply a force pushing the additive chamber towards the product chamber.

The container device or mixing cap respectively may also be used for the mixing of powders, solids, gas, liquids, gels or other product compositions or it may also be used for the mixing of a liquid into a powder, in such case the liquid is the additive and the powder is the product.

In a further variation, a container is provided that allows the mixing of a product and an additive without allowing pollution of the environment to enter in the container before use. In a further advantage, a mixing cap is provided that allows for the preparation of an additive independently from the product in/with which it is intended to be mixed, thereby allowing delocalized production of either the product or the additive.

In a further variant, a mixing cap is provided that allows for the preparation of an additive independently from the product in/with which it is intended to be mixed, thereby allowing differentiated storage for the product or the additive.

In a further variant, a mixing cap is provided that allows for providing users with the ability to meter the amount of additive in the product composition to suit their particular use or taste.

### BRIEF DESCRIPTION OF THE DRAWINGS

The integrated figures represent, by way of example, different embodiments of the subject of the invention, as the figures disclose:

FIG. 1: a schematic view of a first embodiment of a container device containing a mixing cap;

FIG. 2: a schematic view of a first area of an additive chamber of a mixing cap by example;

FIG. 3: a schematic view of the mixing cap with the additive chamber of FIG. 1 at opening;

FIG. 4: a schematic view of a second embodiment of a container device with a mixing cap;

FIG. 5: a schematic view of the additive chamber of the mixing cap according of FIG. 4 at opening;

FIG. 6: a schematic view of a third embodiment of a container device with a mixing cap;

FIG. 7: a schematic view of the additive chamber of the mixing cap according to FIG. 6 at opening;

FIG. 8: a schematic view of a fourth embodiment of a container device with a pierceable flexible shell;

FIG. 9: a schematic view of a fifth embodiment of a container device with a pierceable flexible shell;

FIG. 10: a schematic view of a sixth embodiment of a container device with a mixing cap;

FIG. 11: a schematic view of the additive chamber of the mixing cap according of FIG. 10 at opening; and

FIG. 12: a schematic view of a mixing cap according to a further embodiment.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

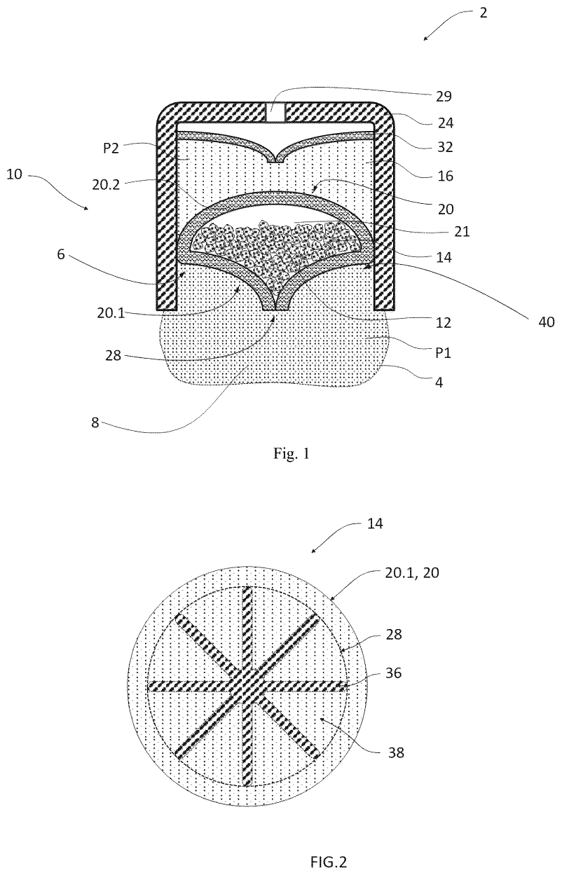

In different embodiments, container devices may be characterized by any of the exemplary characteristics shown in FIGS. 1, 4, 6, 10 and 12, shown after filling, before usage.

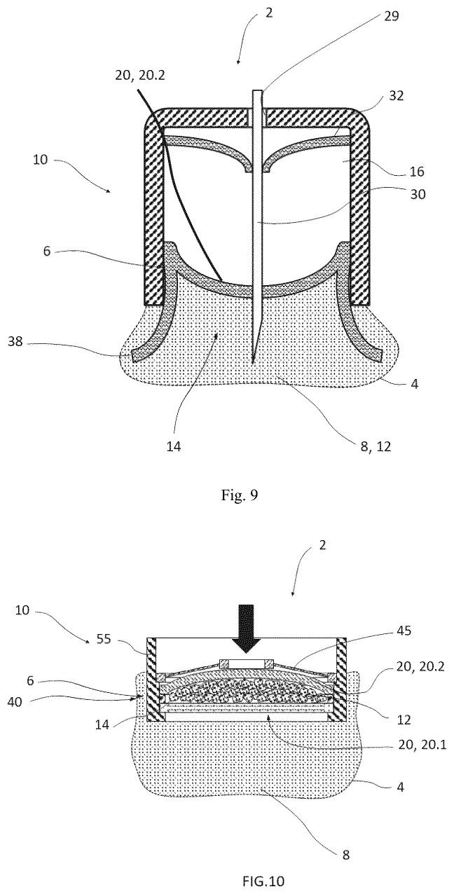

Referring now to FIGS. 1, 4, 6, 8, 9, 10 and 12 container devices 2 are disclosed according to different embodiments. The container device 2 comprises a product chamber 4 for accommodating a product 8 and a mixing cap 10. The product chamber 4 comprises an outwardly disposed product opening 6. The outwardly disposed product opening 6 is exemplarily an opening of the bottle, if the product chamber 4 was formed by a bottle. The outwardly disposed product opening forms a plane 40, which plane 40 is exemplarily shown only in FIGS. 1 and 10. The mixing cap 10 contains a cap 24 and an additive chamber 14 for accommodating an additive 12. The cap 24 is adapted for separating the residual elements of the mixing cap 10 from the surrounding environment to a certain degree. Depending on the use case, further protection of the mixing cap 10 against environmental pollution may be added to the container device 2 (via packaging, seals, etc). Furthermore, the cap 24 may contain a propulsion chamber 16, as shown in FIGS. 1 and 9. The additive chamber 14 contains a flexible shell 20 and an inner cavity 21 surrounded by the flexible shell 20. The additive chamber 14 is immediately arranged or arrangeable respectively at the outwardly disposed product opening 6 of the product chamber 4. The mixing cap 10 may further comprise a propulsion chamber 16, which propulsion chamber 16 is arranged behind the additive chamber 14 relative to the product chamber 4, when the mixing cap 10 is mounted to the product chamber 4. In other words, the additive chamber 14 is in between the product chamber 4 and the propulsion chamber 16, when the mixing cap is mounted to the product chamber 4.

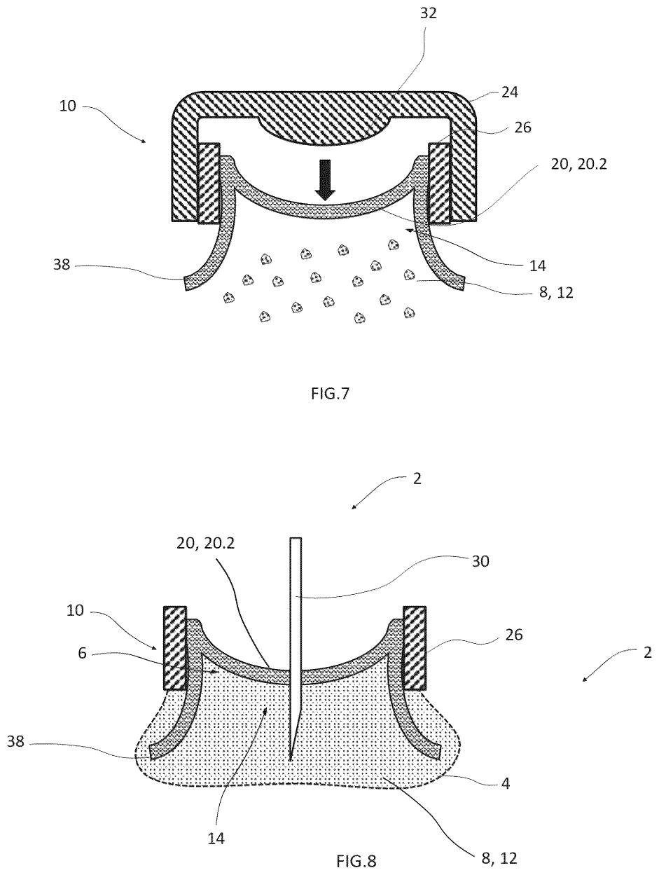

The flexible shell 20 contains a first area 20.1, which is a deformable zone, arranged or arrangeable immediately at the product chamber 4, in other words between the inner cavity 21 of the additive chamber 14 and the product chamber 4. The first area 20.1 is shown as separating the additive 12 from the product 8 according to FIGS. 1, 4, 6, 10 and 12. The first area 20.1 is adapted to be deformed and subsequently open, when a pressure difference between the inner cavity 21 and the product chamber 4 is changed. The first area 20.1 shown in FIGS. 8, 9 and 11 has already been deformed and opened for the product composition 8, 12 to be formed out of product 8 and additive 12. The flexible shell 20 may further contain a second area 20.2, which second area 20.2 is arranged or arrangeable respectively behind the inner cavity 21 relative to the product chamber 4.

The first area 20.1 contains an opening zone 28 containing cuts sealed by a breakable film of any appropriate material or a glue, or may be arranged as a duck valve. The first area 20.1 may be made as a continuous material with zones of reduced thickness that break when it opens, so that it forms a hermetic enclosure for the additive before opening. Optionally, the first area 20.1 contains pre-tensioned and/or mechanically bistable parts that ensure a substantially full closure and a substantially full opening of the opening zone 28.

The first area 20.1 may constitute a gas-tight separation between the additive chamber 14 and the propulsion chamber 16. The propulsion chamber 16 contains a gas under pressure P2, this pressure being lower than the pressure in the product chamber P1. The propulsion chamber 16 contains a duck valve 32 accessible from the outside of the container device 2, for example through a pressurization hole 29, so that gas can be pumped into the propulsion chamber 16 after the mixing cap 10 is assembled unto the product chamber 4, or a highly-refrigerated liquid gas can be inserted in the propulsion chamber 16. Optionally, the propulsion chamber 16 includes at least one pretensioned spring (not shown) to increase its pressure on the additive chamber 14. Optionally, such pretensioned spring may held in pretensioned state during the storage, and released by the opening of the cap via a mechanism as known in the industry. Optionally, the propulsion chamber 16 is replaced by at least one spring dimensioned so as to provide a pushing force on the additive chamber 14 equivalent to the effect of pressure P2.

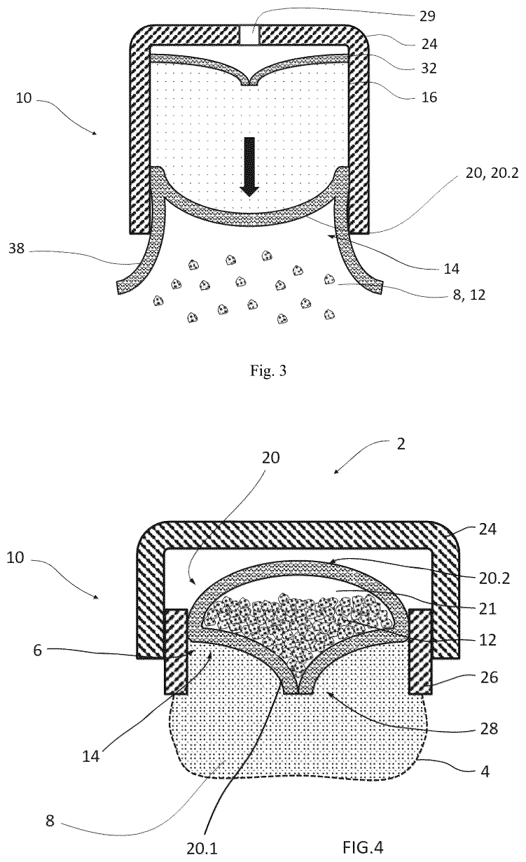

FIG. 3 shows the mixing cap 10 with the additive chamber 14 of FIG. 1 upon opening. The first area 20.1 of the flexible shell 20 has been deformed and then broken open towards product chamber 10. The additive 14 is for instance powder surrounded by a gas. As the first area 20.1 of the flexible shell 20 burst, the powder and the product 8, preferably a liquid, were mixed under high turbulence thereby preventing clumps.

For triggering the mixing, the user may unscrew the cap 24, thereby allowing the pressure P1 in the product chamber 4 to drop towards atmospheric pressure. As soon as the pressure P1 in the product chamber 4 decreases below the pressure P2 of the propulsion chamber 16, the additive chamber deforms as pushed towards the product chamber 4 by the pressure P2 within the propulsion chamber 16, until the opening zone 28 of the first area 20.1 opens and releases the additive 12 into the product chamber 4.

In an embodiment where the propulsion chamber 16 has been replaced by at least one (not shown) spring, when the user unscrews the cap 24, the pressure P1 in the product chamber 4 drops towards atmospheric pressure. The force applied by the spring on the additive chamber 14 is then sufficient to push the additive chamber 14 towards the product chamber 4 with a pressure P2, until the first area 20.1, more precisely the opening zone 28 opens and releases the additive 12 into the product chamber 4.

The opening of the opening zone 28 allows for further deformation, more precisely of the flexible shell 20 of the additive chamber 14, which generates a propulsion effect on the additive 12 towards the product chamber 4, as shown in FIG. 3.

Optionally, the additive chamber 14 includes at least one mechanical structure(s) pre-tensioned and/or presenting mechanically bistable properties to further enhance the additive propulsion/projection effect. The internal shape of the additive chamber 14 is designed so as to not present sharp corners where the additive 12 could remain stuck after the first area 20.1, preferably its opening zone 28, has opened.

FIG. 4 shows a second embodiment of a container device 2 with a mixing cap 10. The mixing cap 10 contains a cap holder 26 arranging the additive chamber 14 on the product chamber 4 and provides a fixation for the cap 24, preferably via a screw mechanism or a bayonet mechanism, or any other appropriate mechanism. The attachment of the cap holder 26 on the product chamber 4 and/or the attachment of the cap 24 on the cap holder 26 optionally includes a breakable film or any other means which prevent tampering of the container device 2.

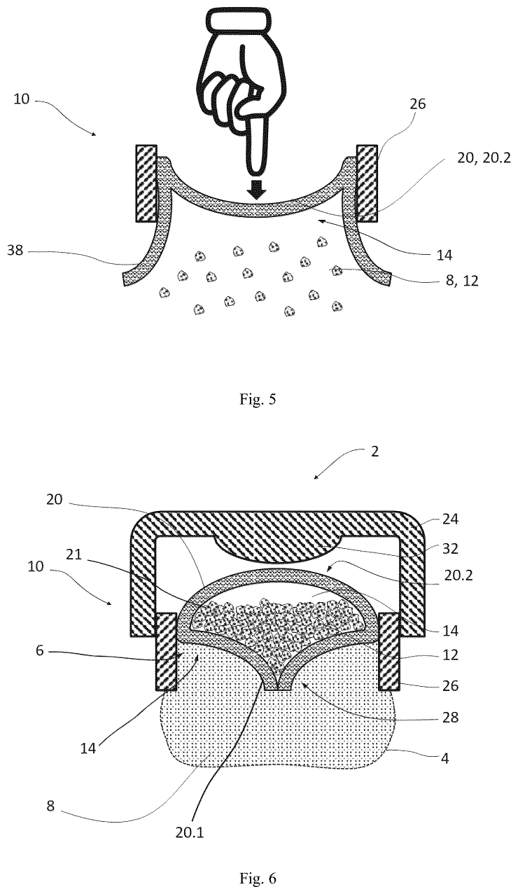

FIG. 5 shows the additive chamber 14 of the mixing cap 10 according of FIG. 4 at opening. In order to mix the additive 12 with the product 8, the user may remove the cap 24 (see FIG. 4), and then apply pressure on the second area 20.2 of the additive chamber 14, for example with a finger, thereby deforming the second area 20.2 of the additive chamber 14 towards the product chamber 4, until the first area 20.1, preferably the opening zone 28 opens and releases the additive 12 into the product chamber 4. The opening of the opening zone 28 allows for further deformation of the additive chamber 14, which generates a propulsion effect on the additive 12 towards the product chamber 4, as shown in FIG. 5.

It is advantageous that there is no opening of the product chamber 4 to the environment before mixing of the product 8 with the additive 12, thereby ensured that the product composition 8, 12 cannot be polluted by the environment. Optionally, the additive chamber 14 includes at least one mechanical structure(s) pre-tensioned and/or presenting mechanically bistable properties to further enhance the additive propulsion/projection effect. The internal shape of the additive chamber 14 is designed so as to not present sharp corners where the additive 12 could remain stuck after the opening zone 28 has opened.

FIG. 6 shows a third embodiment of a container device 2. A cap holder 26 arranges the additive chamber 14 on the product chamber 4 and provides a fixation for the cap 24, via a screw mechanism or a bayonet mechanism, or a similarly appropriate mechanism. The attachment of the cap holder 26 on the product chamber 4 and/or the attachment of the cap 24 on the cap holder 26 optionally includes a breakable film, or any other means known in the industry that allow for the prevention of tampering of the device 2. The cap 24 includes a protrusion 32 facing the second area 20.2 of the flexible shell 20 of the additive chamber 14.

FIG. 7 shows the additive chamber 14 according to FIG. 6 upon opening. In order to mix the additive 12 with the product 8, the user pushes or screws the cap 24 towards the product chamber 4, thereby applying pressure on the second area 20.2 of the flexible shell 20, deforming the additive chamber 14 towards the product chamber 4, until the opening zone 28 opens and releases the additive 12 into the product chamber 4. Optionally, a transmission mechanism (not shown) may be used between the cap 24 and the additive chamber 14, including mechanical elements such as springs, levers and cams (not shown), preferably integrated in the cap 24 so as to multiply or divide the effort the user has to apply on the cap 24 to make this movement. Such transmission mechanism can be used to provide a different interfacing with the user, for example the user may have to lift a lever or lift the cap 24, and the mechanism transforms the pulling effort into a pushing effort on the additive chamber 14, or the user may have to apply a rotative effort on the cap 24, and the mechanism transforms the rotative effort into a pushing effort on the additive chamber 14. The opening of the opening zone 28 allows for further deformation of the additive chamber 14, which generates a propulsion effect on the additive 12 towards the product chamber 4.

There is no opening of the product chamber 4 to the environment before the mixing of the product 8 with the additive 12 to the product composition 8, 12. Therefore, it is ensured that the product composition 8, 12 cannot be polluted by the environment. Optionally, the additive chamber 14 includes at least one mechanical structure(s) pre-tensioned and/or presenting mechanically bistable properties to further enhance the additive propulsion/projection effect. The internal shape of the additive chamber is carefully designed so as to not present sharp corners where the powder could remain stuck after the opening zone has opened.

After mixing the additive 12 with the product 8, typically for edible, drinkable, cosmetic or any other consumable products to be used without specific tools, the user removes the cap 24 and/or the cap holder 26 to pour the product composition 8, 12 out of the product chamber 4. Optionally, for the case of injectable products, the second area 20.2 of the flexible shell 20 is adapted to function as a septum, so that a hollow needle 30 can be inserted through the first and/or second area 20.1, 20.2 of the flexible shell 20 it to extract the product, as shown in FIG. 8 and FIG. 9.

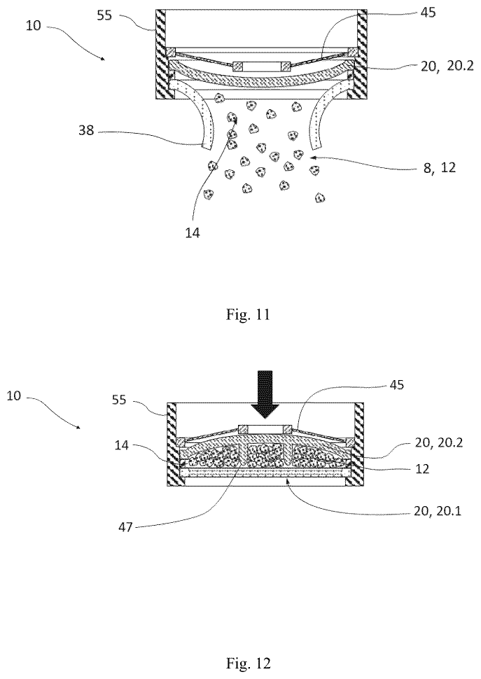

FIG. 10 shows a schematic view of a sixth embodiment of a container device 2 and FIG. 12 shows a schematic view of a mixing cap 10 according to a further embodiment. The mixing cap 10 comprises a bistable element 45, shown in a first stable position within FIG. 10. The bistable element 45 does not effect the flexible shell 20, preferably the second area 20.2 of the flexible shell 20, when in its first position. The flexible shell 20 of FIG. 12 further comprises internal protrusions 47 ensuring that the first area 20.1 of the flexible shell 20 opens before a too high pressure is reached within the additive chamber 14 when opening the additive chamber 14 towards the product chamber, so as to avoid the generation of agglomerated lumps of the additive 12, whereby the internal protrusions 47 is the only difference to the mixing caps 10, shown in FIGS. 10 and 11. Such internal protrusions 47 also protects the additive 12 against compacting during the storage. Furthermore, the additive chamber 14 is arranged to penetrate a plane 40 of the outwardly disposed product opening 6. In other words, the additive chamber 14 is partly arranged within an inner product chamber cavity, wherein the inner product chamber cavity is limited by the walls of the product chamber 4 and furthermore by the plane 40 of the outwardly disposed product opening 6. Not shown is a further embodiment, the additive chamber 14 being completely arranged within the so restricted inner product chamber cavity. Therefore, when mounting the mixing cap 10 onto product chamber 4, the product chamber 4 being filled with the product 8 to its highest possible level of filling, the additive chamber 4 is at least partly immersed or immersible respectively into the product 8. The mixing cap 10 further comprises a fixation element 55 for fixing the additive chamber 14 partially within the inner product chamber cavity.

FIG. 11 shows a schematic view of the mixing cap 10 with its additive chamber 14 according to FIG. 10 at opening. The bistable element 45 may be transferred from the first bistable position (as shown in FIG. 10) to its second bistable position by touching with a finger or any other device able to force the transfer of the bistable element 45 from its first to its second position. When transferred into its second position, the bistable element 45 applies force against the flexible shell 20, preferably the first or second area 20.1, 20.2 in its deformed position, therefore, causing the opening zone of the first area 20.1 of the flexible shell 20 to open towards the product chamber 4, thus causing the product 8 and additive 12 to mix to the product composition 8, 12.

FIG. 2 shows a first area 20.1 of a flexible shell 20 of an additive chamber 14 of a mixing cap 10. When part of a container device, the first area 20.1 is arranged—and when part of a mixing cap, the first area 20.1 is arrangeable between the inner cavity of the additive chamber and the product chamber. The first area 20.1 contains an opening zone 28, which opening zone 28 comprises lines or areas respectively of reduced thickness 36 for breaking when the first area 20.1 is deforming, ensuring a complete and irreversible opening of the additive chamber 14. The end of the lines or areas respectively of reduced thickness 36 define the limitation of the open zone 28. Besides the lines/areas of reduced thickness 36 the open zone 28 also comprises areas of higher thickness 38, which areas of higher thickness belong to the open zone 28. The areas of higher thickness 38 will be flapped open when the additive chamber 14 is opened towards the product chamber as also shown in FIGS. 3, 5, 7 and 9. The area of the opening zone 28 is at least 30%, preferably 50%, more preferably 70% of the first area 20.1.

It should be appreciated that the particular implementations shown and herein described are representative of the invention and its best mode and are not intended to limit the scope of the present invention in any way.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A mixing cap attachable to a product chamber for accommodating a product, the mixing cap including an additive chamber for accommodating an additive, the additive chamber being defined by a flexible shell surrounding an inner cavity of the additive chamber, the flexible shell being deformable to open towards the product chamber for introducing the additive into the product.

2. The mixing cap of claim 1, wherein one of the product and the additive is a solid, preferably a powder, a particulate or a granulate, embedded within a fluid surrounding the solid, and the other is a liquid.

3. The mixing cap of claim 1, the flexible shell having a first area arrangeable immediately or in the vicinity of the product chamber, which first area is arrangeable between the product chamber and the inner cavity, the first area having an opening zone, wherein a deformation of the first area causes opening of the opening zone towards the product chamber, the area of the opening zone constituting at least 30%, preferably 50%, more preferably 70%, of the first area.

4. The mixing cap according to claim 3, the flexible shell having a second area located behind the inner cavity of the additive chamber relative to the first area of the flexible shell, wherein a change of pressure within the inner cavity may be initiated or is causable by a deformation of the second area.

5. The mixing cap according to claim 4, where the product chamber is pressurizable with a pressure P1, the mixing cap including a propulsion chamber located behind the additive chamber relative to the product chamber, the propulsion chamber pressurizable with a pressure P2 that is superior to the ambient pressure and inferior to the pressure P1, the outwardly disposed product opening of the product chamber for allowing a decrease of the pressure of the product chamber from pressure P1 to ambient pressure for the deformation of the first area of the flexible shell, the pressure P2 of the propulsion chamber causing the deformation of the second area of the flexible shell.

6. The mixing cap according to claim 4, where the product chamber is pressurizable with a pressure P1, the mixing cap including a spring located behind the additive chamber relative to the product chamber, the spring able to apply a force for the deformation of the second area of the flexible shell towards the product chamber with a pressure P2 that is superior to the ambient pressure and inferior to the pressure P1, the outwardly disposed product opening of the product chamber allowing for a decrease of the pressure of the product chamber from the pressure P1 to ambient pressure for the deformation of the first area of the flexible shell.

7. The mixing cap according to claim 4, where the second area of the flexible shell is manually deformable towards the first area of the flexible shell for deformation of the first area of the flexible shell for opening the additive chamber towards the product chamber.

8. The mixing cap according to claim 3, wherein the first area of the flexible shell contains pre-tensioned and/or mechanically bistable parts that ensure a substantially full closure and a substantially full opening is adapted for projecting the additive towards the product for mixing of the additive with the product.

9. The mixing cap according to claim 1, including a bistable element, which bistable element is adapted to not effect the flexible shell in a first stable position and causing the deformation of the flexible shell in a second stable position to enhance the projection of the additive.

10. The mixing cap according to claim 1, wherein the flexible shell comprises internal protrusions.

11. The mixing cap according to claim 1, where the first and/or the second areas of the flexible shell is pierceable for allowing an extraction of the product or of the product composition, preferably via a hollow needle.

12. Medical system, preferably a syringe, an intravenous line or subcutaneous line, the medical system connectable to a patient and including the mixing cap according to claim 1.

13. A container device for accommodating a composition of a product and an additive, the container device including
a mixing cap according to any of the preceding claims,
a product chamber
wherein the mixing cap is attached to the outwardly disposed product opening of the product chamber.

14. The container device of claim 13, the product chamber being pressurizable with a pressure P1, the mixing cap including a propulsion chamber located behind the additive chamber relative to the product chamber, the propulsion chamber being pressurizable with a pressure P2 that is superior to an ambient pressure and inferior to the pressure P1, the outwardly disposed product opening allowing for a decrease of the pressure of the product chamber from P1 to ambient pressure, the pressure P2 of the propulsion chamber generates a deformation and the opening of the additive chamber towards the product chamber.

15. The container device of claim 13, where the additive chamber is arranged to penetrate a plane of the outwardly disposed product opening or where the additive chamber is arranged within the product chamber.

16. The container device according to claim 13, where the composition after mixing is an edible, drinkable, ingestible or injectable therapeutic, an edible, drinkable, or ingestible consumable, or a cosmetic composition.

18. The method of mixing a product and an additive, the flexible shell having a first area arranged immediately at the product chamber and a second area located behind the inner cavity of the additive chamber relative to the first area of the flexible shell,
deforming the second area of the flexible shell and therefore changing the pressure within the inner cavity, preferable raising the pressure within the inner cavity, and
the changing pressure within the inner cavity causing deforming of the first area until the additive chamber opens open towards the product chamber.

19. A method of filling a container device for accommodating a composition, the container device including a product chamber for accommodating a product, which product chamber has an outwardly disposed product opening, and a mixing cap according to claims 1 to 9 for accommodating an additive, the method including the steps of
providing an additive chamber of the mixing cap with an additive,
filling the product chamber with the product under pressurized atmosphere, or filling the product chamber with the product at ambient pressure and adding a highly-refrigerated liquid gas in the product chamber, preferably before closing; and
attaching the mixing cap to the product chamber.

20. The method according to claim 19, comprising the further step of:
filling a propulsion chamber of the mixing cap with pressurized gas, or inserting a highly-refrigerated liquid gas in the propulsion chamber, or inserting a spring in the mixing cap behind the additive chamber to apply a force pushing the additive chamber towards the product chamber.
